(19) United States
(12) Patent Application Publication
(10) Pub. No.: US 2005/0170127 A1
(43) Pub. Date: Aug. 4, 2005

(54) Stamp sheetlet

(76) Inventors: Rod Whitmond, Monroe, CT (US); Christopher Giles, Foster City, CA (US); Andrew Mackenzie, Paris (FR)

Correspondence Address: PERMAN & GREEN, 425 POST ROAD, FAIRFIELD, CT, 06824, US

(21) Appl. No.: 10/768,816

(22) Filed: Jan. 30, 2004

(51) Int. Cl. B32B 9/00

(52) U.S. Cl. 428/42.3

(57) ABSTRACT

A foldable stamp sheet that includes a backing sheet, at least one label on the sheet, the label having an adhesive backing that allows it to adhere to the backing sheet in a non-permanent manner, each label having a scored section along a midline of the label, at least one stamp formed on each label, at least one pull tab on the sheet, the pull tabs being positioned in an area where the sheet is to be folded when the pull tab is removed from the sheet.

### BACKGROUND OF THE INVENTION

1. Field of the Invention

The present invention is directed to a sheet of stamps or labels that can be folded in at least half in order to be fit into a small holder, such as for example, a wallet or credit card holder.

2. Brief Description of Related Developments

Labels for postage and postage indicia can be printed on sheets. The sheets can comprise any suitable sheet of labels onto which markings can be printed. When needed for use, the labels can be separated from the backing material and applied to the article. The sheets of labels can come in various dimensions and the labels thereon are also suitably sized for the particular application. For example, where the sheets of labels are sheets of stamps, the dimensions of the stamps should be suitable for use with the United States Postal Service (“USPS”). Although the term “stamps” is used herein, it will be understood that the present invention can be applied to other label applications. For example, in one embodiment, the sheets could comprise sheets of postage meter tape, or strips of meter stamps on the tape. Vending stations such as the Neopost Kiosk™ can be used to generate sheets of stamps or other postage indicia.

For example, the Neopost Kiosk™ is an on-line, self service postage kiosk that dispenses US Postage. The stamps or postal indicia could be dispensed, for example for purposes of this invention, on a sheet. The sheet would include the number of stamps purchased.

### SUMMARY OF THE INVENTION

The present invention is directed in a first aspect to a foldable stamp sheet. In one embodiment the sheet comprises a backing sheet, at least one label on the sheet, the label having an adhesive backing that allows it to adhere to the backing sheet in a non-permanent manner, each label having a scored section along a midline of the label, at least one stamp formed on each label, at least one pull tab on the sheet, the pull tabs being positioned in an area where the sheet is to be folded when the pull tab is removed from the sheet.

In another aspect the present invention is directed to a method of forming a sheet of stamps. In one embodiment the method comprises die cutting a section of a roll of thermal paper on an adhesive backing to form a series of rows of labels and a receipt area, the rows of labels being perforated along a center to form a row of two stamps. Removing excess thermal paper material surrounding the die cut labels and receipt section. Imprinting each stamp on the roll with a postal indicia and imprinting the receipt area with details of a transaction to purchase the postal indicia formed on the stamps. Wherein each stamp on the sheet can be individually removed for use.

In a further aspect the present invention is directed to a stamp sheet. In one embodiment the stamp sheet comprises a backing sheet, a labeling material on the sheet, the labeling material being separated into portions, a first imprintable portion comprising a first row of two stamps and a second adjacent row of two stamps, and a vertical score down the middle of the first and second row, a second imprintable portion comprising a first row of two stamps and a second adjacent row of two stamps, and a vertical score down the middle of the first and second row, the first portion and the second portion being separated by a pull tab between the first portion and the second portion, a third imprintable portion comprising a single row of two stamps separated by a vertical score, the third portion separated from the second portion by another pull tab, a fourth imprintable portion comprising a single label piece separated from the third portion by an area devoid of any labeling material, and wherein an outer perimeter surrounding the first, second, third and fourth portion is devoid of any labeling material.

### BRIEF DESCRIPTION OF THE DRAWINGS

The foregoing aspects and other features of the present invention are explained in the following description, taken in connection with the accompanying drawings, wherein:

FIG. 1 is an illustration of one embodiment of a sheet of stamps incorporating features of the present invention.

FIG. 2 is an illustration of one embodiment of the sheet of stamps of FIG. 1 folded in accordance with features of the present invention.

### DETAILED DESCRIPTION OF THE PREFERRED EMBODIMENT(s)

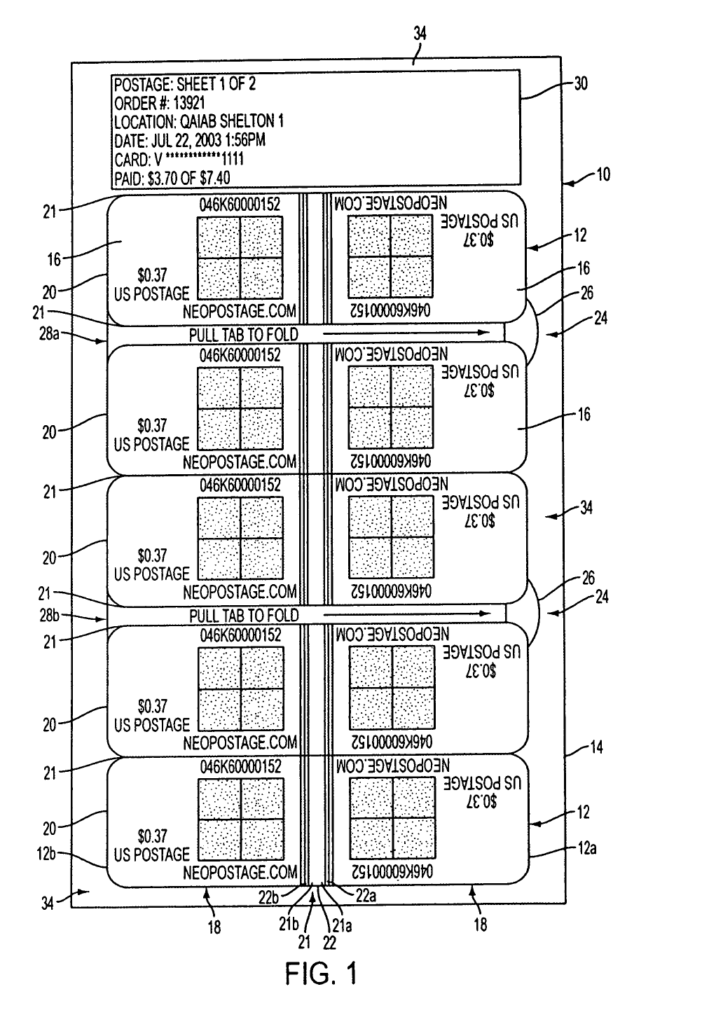

In one embodiment as shown in FIG. 1, the sheet 10 comprises a set of for example ten indicia marked labels or stamps 12. Each label 12 includes all of the information required to be a valid form of postage. Although ten labels 12 are shown in FIG. 1, it will be understood that any suitable numbers of labels and/or stamps could be formed on the sheet 10. Also, although the present invention is described in terms of postage and stamps, the present invention can be used in any label application. It is a feature of the invention to be able to fold the sheet 10 of labels 12 into a smaller size or package, while maintaining the integrity of the label and the label adhesive. It is also a feature of the present invention that the label backing 14 is able to be folded in conjunction with the label 12 without having the labels 12 separate from the backing 14 until desired.

Referring to FIG. 1, the sheet 10 comprises for example, two columns 18 and five rows 20 of labels 12. Each label 12 generally comprises two pieces or halves, 12a and 12b, each half comprising a separate stamp 16 or label. For example, as shown in FIG. 1, each label portion 12a and 12b comprises a stamp 16 with postage indicia imprinted or formed thereon. Each label row 20 that is adjacent another label row 20 has a precut or score between the adjacent rows that allows for removal of one label half, 12a or 12b, with removal of the adjacent label half or adjacent label row. In alternative embodiments, any suitable number of rows and columns could be used. A receipt 30 or other such information can also be included on the sheet 10. It is a feature of the present invention to integrate a receipt 30 with the sheet 10, while maintaining the foldability of the sheet 10 and labels 12. Although each label 12 shown in FIG. 1 is divided into two portions 12a and 12b, each comprising a stamp 16. The label 12 can be divided into any suitable number of portions to form any desired number of stamps.

In one embodiment as shown in FIG. 1, the labels 12 are scored with score 22 to divide each label 12 into the respective portions, or as shown in FIG. 1, approximate halves, where each half comprises a stamp 16. The score is used to separate the stamps from one another.

In one embodiment, referring to FIG. 1, the sheet 10 can also include pull tabs 24 at periodic intervals on the sheet 10 between labels 12. The pull tabs 24 divide the sheet 10 into sections for folding purposes. In FIG. 1, two pull tabs 24 are shown, allowing the sheet 10 to be folded into approximate thirds when the pull tabs 24 are removed from the sheet 10. This allows the sheet 10 and stamps to be folded to an approximate credit card size that can be fit in for example, a wallet. Thus, if postage is printed via a vending machine in small to medium amounts, the sheets can be folded to fit conveniently in a wallet or credit card type holder.

As shown in FIG. 1, the sheet 10 has a plurality of parallel rows 21 of fracturable lines of perforations or other indentations formed in the paper and a plurality of columns 19 that intersect the rows 21 of perforations or lines to divide each row 20 of labels 12 into individual stamps 16. When a customer desires to use a stamp 16, the customer removes one or more of the individual stamps. The stamps 16 are removed by fracturing the stamp material along the rows 21 and columns 19 that form a dividing line between stamp portions.

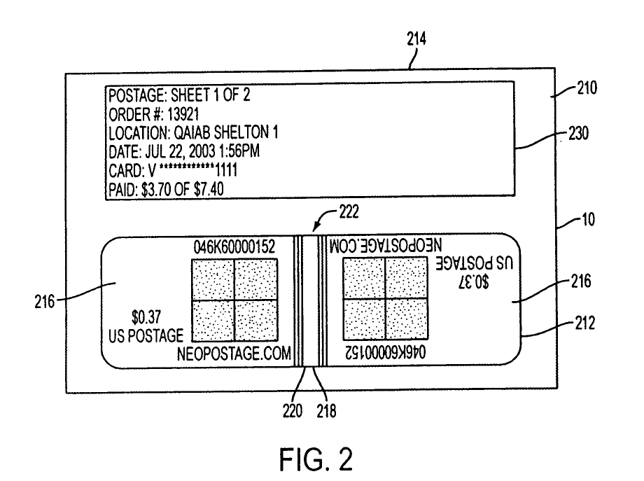

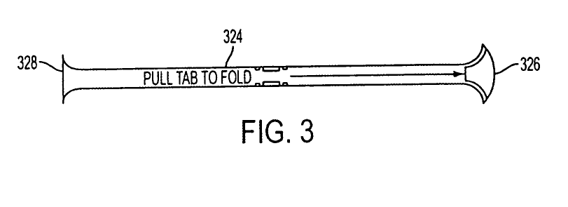

In one embodiment, referring to FIG. 2, an example of a folded sheet 210 is illustrated. In this embodiment, the pull tabs 24 of FIG. 1 have been removed and the sheet 10 folded at each indicated area to result in the folded sheet 210. Here, two stamps 216 are shown on a portion of the folded sections, together with the receipt 230. On a reverse side, not shown, of the folded sheet 210, one might have two rows of labels 212 with stamps 216. The size of the folded sheet 210 shown in FIG. 2 is approximately the size of a credit card, although the folded sheet 210 could be sized to any suitable dimension. In one embodiment, the stamp 216 could include one serrated edge 218 along which an ink, such as for example, a fluorescent ink is placed. A marked or colored stripe 222 can be formed or included along a middle portion of the label 212. A similar marking is shown in FIG. 1, as strip 21, with portions 21a and 21b. In alternate embodiments, any suitable design or color configuration can be used or implemented.

Referring to FIG. 1, in one embodiment, the pull tab 24 can have one end 26 that is larger or wider than the other end 28 and allows a user to be able to grasp the pull tab 24 and separate it from the sheet 14. One illustration of a pull tab 24 of FIG. 1 is shown in FIG. 3. The pull tab 324 is generally of the same material as the labels 12 of FIG. 1. The pull tab 324 has two ends, 326 and 328. The end 326 is somewhat larger or wider than the end 328 in order to allow a user to grasp the end 326 to remove the pull tab 324. Any suitable shape for the pull tab 324 can be utilized. The width of the pull tab 324 is enough to allow the sheet to be folded along a void left by the pull tab 324 after it is removed.

During the processing phase of the 14 sheet 10 and labels 12, all of the labeling material can be removed from around the edge 34 of the sheet 10. The webbing is stripped out so that the cutter does not have to cut through the adhesive label and the gum. The labeling material 34 generally comprises the material that surrounds the labels 12 and receipt area 30, after the die cuts form the labels 12 and receipt cover 30. When the printer gets a roll of labels it comes as a huge long roll of white thermal paper on an adhesive backing. The dies are made to create the cuts on the thermal paper so that the stamps can be removed accordingly. This provides a long roll of about 2500-3500 labels on one roll. As the sheets are printed for example in the kiosk, the sheets are cut from the roll into separate sheets (of for example ten). If the webbing (outside edge of thermal paper 34) is not stripped, the blade that cuts the sheets has to cut through the thermal paper, the adhesive and the backing. This causes the blade to gum up. However, the integrity of the roll and its strength is maintained even when the webbing removed. Thus, all of the excess labeling can be removed from the areas where the blade cuts to prevent the cutting machine from jamming. This prevents the cutting device from-gumming up during the processing of the sheets and allows for easier folding of the sheet and removal of the stamps. The sheets and stamps can be cut using any conventional cutting means, such as for example, long roll, or cut dies. The shapes of the labels 12, stamps 16 and receipt 30 can be any suitable shape for the particular application.

In one embodiment, information can be printed on the side of the sheet 10 that opposes the stamp face, i.e. on the back side of the sheet. Thus, the stamps would be on one side and the information on the other. The information could include for example advertising, a coupon or other product or service advertising. Generally, any information that is suitable for printing can be printed on the sheet 10. In one embodiment, the information could be printed or formed on the portion of the sheet 10 that is exposed when a stamp on a label portion is peeled off.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

1. A foldable stamp sheet comprising:
a backing sheet;
at least one label on the sheet, the label having an adhesive backing that allows it to adhere to the backing sheet in a non-permanent manner;
each label having a scored-section along a midline of the label;
at least one stamp formed on each label;
at least one pull tab on the sheet, the pull tabs being positioned in an area where the sheet is to be folded when the pull tab is removed from the sheet.

2. The stamp sheet of claim 1 further comprising at least one serrated edge along a midline of the sheet along which an ink is placed.

3. The stamp sheet of claim 2 wherein the ink is a fluorescent ink.

4. The stamp sheet of claim 2 wherein the serrated edge is formed along the scored section.

5. The stamp sheet of claim 1 further comprising a receipt section on the sheet, the receipt section being separated from the stamp and being removable from the sheet.

6. The stamp sheet of claim 1 further comprising a printable section on a side of the sheet opposite a label side of the sheet, the printable section including an advertisement or other printed information.

7. The stamp sheet of claim 1 further comprising a precut between adjacent stamps that allows adjacent stamps to be separated from one another.

8. The stamp sheet of claim 1 further comprising a precut along each edge of the pull tab that is adjacent a label portion to allow the pull tab to be removed without removal of the adjacent label.

9. The stamp sheet of claim 1 wherein a size of a folded stamp sheet is approximately equivalent to a size of a credit card.

10. A method of forming a sheet of stamps comprising:
die cutting section of a roll of thermal paper on an adhesive backing to form a series of rows of labels and a receipt area, the rows of labels being perforated along a center to form a row of two stamps;
removing excess thermal paper-material surrounding the die cut labels and receipt section;
imprinting each stamp on the roll with a postal indicia; and
imprinting the receipt area with details of a transaction to purchase the postal indicia formed on the stamps;
wherein each stamp on the sheet can be individually removed for use.

11. The method of claim 10, further comprising die cutting a pull tab at predetermined intervals along each section wherein one end of the pull tab is wider than another end to allow the pull tab to be removed easily.

12. The method of claim 11 wherein the predetermined intervals allow the section to be folded into a credit card size when each pull tab in the section is removed.

13. The method of claim 10 further comprising marking a center perforation line between stamps in each row with an ink.

14. The method of claim 10 further comprising imprinting one column of stamps upside down as compared to another adjacent column of stamps separated by the perforation.

15. A stamp sheet comprising:
a backing sheet;
a labeling material on the sheet; the labeling material being separated into portions;
a first imprintable portion comprising a first row of two stamps and a second adjacent row of two stamps, and a vertical score down the middle of the first and second row;
a second imprintable portion comprising a first row of two stamps and a second adjacent row of two stamps, and a vertical score down the middle of the first and second row, the first portion and the second portion being separated by a pull tab between the first portion and the second portion;
a third imprintable portion comprising a single row of two stamps separated by a vertical score, the third portion separated from the second portion by another pull tab;
a fourth imprintable portion comprising a single label piece separated from the third portion by an area devoid of any labeling material; and
wherein an outer perimeter surrounding the first, second, third and fourth portion is devoid of any labeling material.
